(19) United States
(12) Patent Application Publication
(10) Pub. No.: US 2022/0366486 A1
(43) Pub. Date: Nov. 17, 2022

(54) DECENTRALIZED AUCTION PLATFORM

(71) Applicant: Metadyn, New York, NY (US)

(72) Inventors: Kevin MCCOY, New York, NY (US); Tammo MUELLER, New York, NY (US); Jason BRUMWELL, New York, NY (US)

(21) Appl. No.: 17/744,424

(22) Filed: May 13, 2022

Related U.S. Application Data
(60) Provisional application No. 63/188,849, filed on May 14, 2021.
(60) Provisional application No. 63/190,588, filed on May 19, 2021.

(51) Int. Cl. G06Q 30/08; H04L 9/00; H04L 9/32; G06Q 20/38; G06Q 20/06

(52) U.S. Cl. CPC G06Q 30/08; H04L 9/50; H04L 9/3239; G06Q 20/389; G06Q 20/06; H04L 2209/56; H04L 2209/60

(57) ABSTRACT

Systems and methods for managing media, such as digital content, using blockchain technology are described. For example, the systems and methods can facilitate the storage of documents, such as legal documents, along with associated tokens (e.g., non-fungible tokens or NFTs) to a blockchain or similar platform, such as the Ethereum decentralized platform. Further, the systems and methods access digital wallet information or contents and provide digital content to users, such as during auctions or within online marketplaces, when the digital wallet information indicates certain contents or tokens.

### CROSS-REFERENCE TO RELATED APPLICATIONS

This application claims priority to U.S. Provisional Patent Application No. 63/188,849, filed on May 14, 2021, entitled “STORING DOCUMENTS ALONG WITH TOKENS WITHIN THE ETHEREUM PLATFORM”, and U.S. Provisional Patent Application No. 63/190,588, filed on May 19, 2021, entitled “DECENTRALIZED AUCTION PLATFORM FOR DIGITAL CONTENT DISTRIBUTION”, which are hereby incorporated by reference in their entirety.

### BACKGROUND

A blockchain is a distributed database that includes and maintains an ever-growing list of data records. Being distributed, the blockchain is effectively tamper and revision proof. There are many applications for a blockchain, including the public ledgers of transactions for cryptocurrencies, such as bitcoin, the execution of smart contracts, the deployment of non-fungible tokens, or NFTs, (e.g., via the Ethereum platform), and so on.

For example, the blockchain enables decentralized digital currencies, because bitcoin transactions are verified by network nodes (e.g., addresses), and recorded in the public, distributed ledgers. Further, the blockchain can support other decentralized applications, such as smart contracts, where digital currency (e.g., ether, or ETH) run applications and other services via a decentralized platform.

### BRIEF DESCRIPTION OF THE DRAWINGS

Various embodiments are disclosed in the following detailed description and accompanying drawings.

FIG. 1 is a block diagram illustrating a suitable computing environment for performing transactions associated with digital content.

FIG. 2 is a block diagram illustrating components of a content management system.

FIG. 3 is a flow diagram illustrating a method for managing the use of digital content.

FIG. 4 is a flow diagram illustrating a method for transferring rights assigned to digital content between entities.

FIG. 5 is a schematic diagram illustrating a transfer of rights assigned to digital content between entities.

FIGS. 6A-6B are schematic diagrams illustrating a transfer of digital currency during a rights transaction for digital content.

FIG. 7 is a schematic diagram illustrating a creation of a right assigned to digital content.

FIG. 8 is a schematic diagram illustrating a transfer of a right assigned to digital content.

FIG. 9A is a schematic diagram illustrating a cloning of a right assigned to digital content.

FIG. 9B is a schematic diagram illustrating a transfer of a right assigned to digital content using rightbase supplementation of a transaction.

FIG. 10 is a block diagram illustrating systems of a digital content item marketplace.

FIG. 11A is a flow diagram illustrating a method for managing content within a social network service.

FIG. 11B is a flow diagram illustrating a method for sharing content within a social network service.

FIG. 12 is a block diagram illustrating interactions between components during the creation of a digital contract of rights to a digital content item.

FIG. 13 is a flow diagram illustrating a method for generating a digital contract of rights to a digital content item.

FIG. 14A is a representation of a digital contract of rights to a digital content item.

FIG. 14B is a representation of information associated with a digital content item that is included in a blockchain transaction.

FIGS. 15A-F are display diagrams illustrating example user interfaces for registering a digital content item.

FIG. 16 is a diagram illustrating flows between a smart contract and a decentralized platform.

FIG. 17 is a flow diagram illustrating an example method for providing digital content to a user.

FIG. 18 is a block diagram illustrating a suitable network architecture for accessing a decentralized auction platform via websites.

FIG. 19 is a flow diagram illustrating an example method for establishing an online auction service for a digital content item.

FIG. 20 is a block diagram illustrating a system for authorizing access to a digital content item via contents of a digital wallet.

FIG. 21 is a flow diagram illustrating an example method of authorizing access to a digital content item.

In the drawings, some components are not drawn to scale, and some components can be combined for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

The use and distribution of digital content, such as digital documents, images, multimedia, and so on, has historically been difficult to track, control and/or protect by owners of the digital content, especially online. For example, social networks, messaging, micro-blogs, and so on, provide easy mechanisms for users to view, share, and appropriate content provided by others. Content creators and owners, therefore, often face problems when attempting to assert the ownership of their works and, in some cases, license or receive remuneration for the use of their works by others.

Systems and methods for managing media, such as digital content, using blockchain technology are described. For example, the systems and methods can facilitate the storage of documents, such as legal documents, along with associated tokens (e.g., non-fungible tokens or NFTs) to a blockchain or similar platform, such as the Ethereum decentralized platform.

In some embodiments, the systems and methods provide an auction platform for auctioning or otherwise selling digital content items, such as NFTs and other blockchain-based or blockchain-issued content. For example, the auction platform can utilize the Ethereum platform to generate/mint NFTs representing the digital content items and facilitate auctions for ownership or rights to the content represented by the generated NFTs.

In some embodiments, the systems and methods facilitate the control of user access to digital content items, such as NFTs, based on the contents of digital wallets associated with the users. For example, the digital wallet can have certain contents (e.g., digital currency, special tokens) that facilitate access to digital content or other online services for a user.

The following is a detailed description of example embodiments to illustrate the principles of the technology. The embodiments are provided to illustrate aspects of the invention, but the technology is not limited to any embodiment. The scope of the technology encompasses numerous alternatives, modifications and the equivalent.

Numerous specific details are set forth in the following description in order to provide a thorough understanding of the technology. However, the technology may be practiced according to the claims without some or all of these specific details. For the purpose of clarity, technical material that is known in the technical fields related to the technology has not been described in detail so that the technology is not unnecessarily obscured.

### Suitable Computing Environment

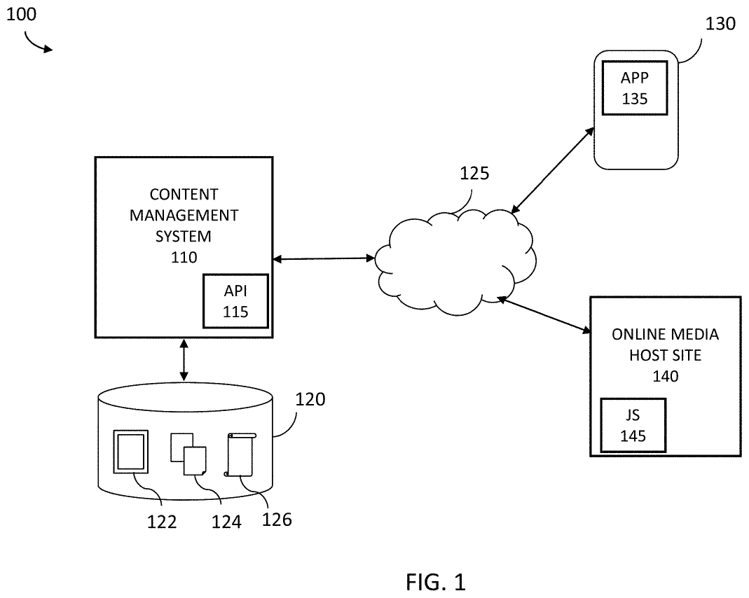

FIG. 1 is a block diagram illustrating a suitable computing environment 100 via which to manage media using a blockchain. The computing environment 100 includes a content management system 110, which provides an Application Programming Interface (API) service 115 and/or via deployable software (local or cloud-based) configured to enable users, customers, enterprise systems, and so on, to access various different media management functions provided by the content management system 110. For example, a user at a computing device 130 (such as a mobile device, laptop, and so on) may upload, over a network 125 (e.g., the Internet), such as via a mobile application 135, content to an online media host site 140 that supports a website or service that presents content to users.

The online host media site 140 may contain different scripts or modules, such as a javascript module 145, that facilitate communicating over the network 125 to the content management system 110 (e.g., calling the API 115), in order to access and retrieve certain information associated with the uploaded content, such as rights information, ownership information, licensing or purchasing information, unique identifiers, provenance information, and so on. The content management system 110 may store such information via blockchain technology (e.g., to the Ethereum platform) in various databases or memory, either local to the system or in various cloud-based storage services, such as in repositories at a peer-to-peer storage network (e.g., IPFS or the InterPlanetary File System).

For example, a database 120 may include content information 122 associated with digital content items, such as information describing the digital content items, information representing the content items (e.g., hash values that represent the digital content items), metadata associated with the digital content items (e.g., metadata stored in one or more .json formatted files), and so on.

The database 120 may also include contract data or information 124, such as information associated with rights assigned to the digital content items and/or use of the digital content items, and one or more public ledgers, such as blockchains associated with the digital content items that track transactions performed with respect to the digital content items.

Of course, the database 120 may include other types of data or information, such as user information (e.g., information associated with owners or recipients of content), payment information (e.g., information associated with monetary exchanges for content), online host information (e.g., information associated with various online hosts of content, such as host site 140), and so on.

As described herein, the content management system 110 may include various components that perform digital currency transactions in order to establish the transfer of rights of digital content between entities (e.g., between a content owner/provider and a content acquirer/recipient) and generate, create, update, or otherwise maintain public ledgers of the performed transactions, such as distributed public ledgers for the digital content.

Further details regarding the components and methods performed by the content management system 110, and other associated systems, are described in the following section (and elsewhere).

FIG. 1 and the components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network or cloud 125 can be any network, ranging from a wired or wireless local area network (LAN), to a wired or wireless wide area network (WAN), to the Internet or some other public or private network, to a cellular (e.g., 4G, LTE, or 5G network), and so on. While the connections between the various devices and the network 125 and are shown as separate connections, these connections can be any kind of local, wide area, wired, or wireless network, public or private.

Further, any or all components depicted in the Figures described herein can be supported and/or implemented via one or more computing systems, servers, or cloud-based systems. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer such as an exercise machine, display device, or mobile or portable device, and thus, while certain hardware platforms are described herein, aspects of the system are equally applicable to nodes on a network. In some cases, the mobile device or portable device may represent the server portion, while the server may represent the client portion.

### Examples of Managing Digital Content and Content Marketplaces

As described herein, the systems and methods utilize various aspects of blockchain technology to manage the attribution, appropriation, distribution, transfer, and other actions associated with digital media (e.g., text-based content, audio-based content, video-based content, image-based content, and so on), content associated with the digital media, and/or rights to the media (e.g., represented by contracts), such as user-created content that is presented to other users via various different online environments, such as websites, social networks, blogs, micro-blogs, auction platforms, decentralized platforms, and so on.

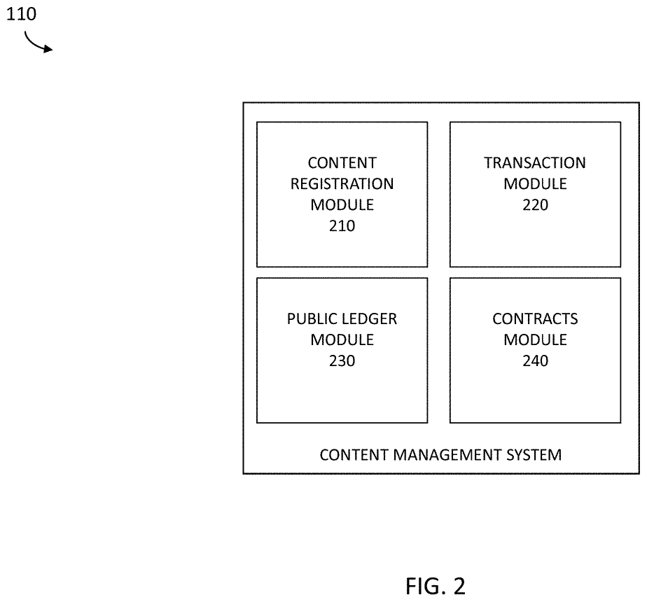

FIG. 2 is a block diagram illustrating components of the content management system. 110. The content management system 110 may include one or more modules and/or components to perform operations for managing the use of digital content and/or rights to the use of the digital content. The modules and/or components may be hardware, software, or a combination of hardware and software, and may be executed by one or more processors. For example, the content management system 110 may include a content registration module 210, a transaction module 220, and a public ledger module 230.

In some embodiments, the content registration module 210 is configured and/or programmed to register digital content items received from owners of the digital content items. For example, the content registration module 210 may include a content input component that is configured to receive input from the owners of the digital content items, wherein the input includes digital content items provided to an online website (e.g., via mobile application 135 or via host site 140) to be displayed by the online website, and information identifying rights to be assigned to use of the digital content items.

In some embodiments, the transaction module 220 is configured and/or programmed to perform bitcoin, ether, or other digital currency transactions to generate public ledger entries that represent rights transfers of the digital content items between providers and recipients. For example, the transaction module 220 may perform a transaction to transfer rights to a digital content item by transferring digital currency from a first node address associated with a current owner of rights to the digital content item to a second node address associated with a recipient of the rights to the digital content item. In some embodiments, the transfer of rights represents and/or activates a contractual clause or usage term(s) within an associate contract for a given piece of media or content.

In some embodiments, the public ledger module 230 is configured and/or programmed to maintain a public ledger of the generated public ledger entries for the registered digital content items. For example, the public ledger module 230 generates a blockchain of transaction entries for each registered digital content item, such as a transaction entry representing the transfer of digital currency from a first node address associated with a current owner of rights to the digital content item to a second node address associated with a recipient of the rights to the digital content item.

In some embodiments, the content management system 110 may also include a contract module 240 that is configured and/or programmed to maintain contracts for registered digital content items. For example, the contract module 240 may access digital contracts for digital content items, such as contracts that include information identifying a right type for the digital content items, the node address (e.g., bitcoin address) for the rights assigned to the digital content items, and the owner (e.g., entity) that owns the rights to the digital content items.

In order to maintain the contracts, the contract module 240 may modify, amend, or change digital contracts that define the rights assigned to the digital content items in response to performed bitcoin transactions, wherein the digital contracts include information identifying right types for the rights assigned to the digital content items, information identifying bitcoin addresses associated with the rights assigned to the digital content items, and information identifying owners of the digital content items.

Therefore, the content management system 110 may manage the rights to registered digital content with the public ledger module or component 230, which generates a blockchain of transaction entries for digital content, wherein each of the transaction entries represents a transfer of a right to digital content from a provider of the digital content to a recipient of the digital content, and the transaction module or component 220, which performs transactions to transfers rights of the digital content from providers to recipients, wherein the performed transactions include transfers of digital currency between bitcoin or ether (or other digital currency) addresses associated with the providers of the digital content and bitcoin or ether (or other digital currency) addresses associated with the recipients of the rights to the digit content.

As described herein, the content management system performs various methods and processes when tracking creation and ownership of digital content items, such as by utilizing digital currency transactions as representations of rights transfers between entities, and maintaining a list of such transactions as a chain of provenance for the digital content items in public ledgers and other blockchains.

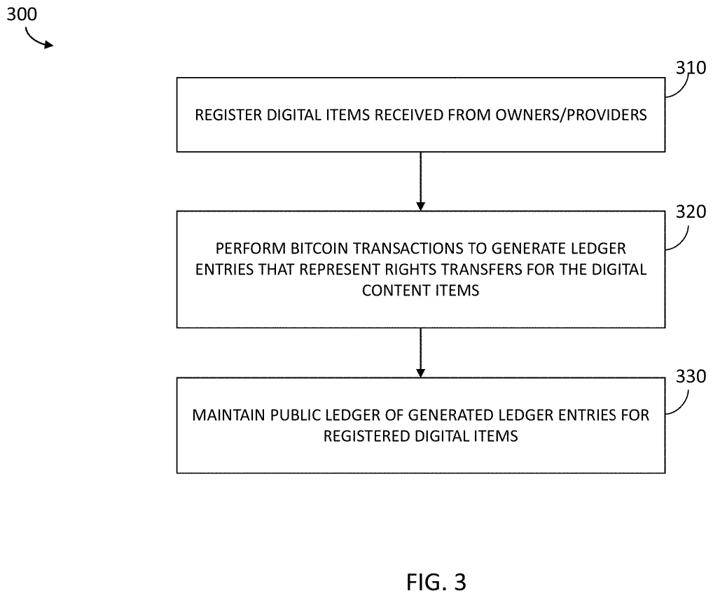

FIG. 3 is a flow diagram illustrating a method 300 for managing the use of digital content. The method 300 may be performed by the content management system 300 and, accordingly, is described herein merely by way of reference thereto. It will be appreciated that the method 300 may be performed on any suitable hardware or devices/components within the content management system 110.

In operation 310, the content management system 110 registers digital content items received from owners of the digital content items (or, in some embodiments, registers placeholders or representations of offline, or non-digital content items). For example, the content registration module 210 may include a content input component that is configured to receive input from the owners of the digital content items, wherein the input includes digital content items provided to an online website (e.g., via mobile application 135 or via host site 140) to be displayed by the online website, and information identifying rights to be assigned to use of the digital content items.

In operation 320, the content management system 320 performs bitcoin (or other digital currency) transactions to generate public ledger entries that represent rights transfers of the digital content items between providers and recipients. For example, the transaction module 220 may perform a transaction to transfer rights to a digital content item by transferring digital currency from a first node address associated with a current owner of rights to the digital content item to a second node address associated with a recipient of the rights to the digital content item.

In operation 330, the content management system 330 maintains a public ledger of the generated public ledger entries for the registered digital content items. For example, the public ledger module 230 generates a blockchain of transaction entries for each registered digital content item, such as a transaction entry representing the transfer of digital currency from a first node address associated with a current owner of rights to the digital content item to a second node address associated with a recipient of the rights to the digital content item.

As described herein, the content management system 330 performs various of types of digital currency transactions when establishing, creating, or transferring rights to digital content items for or between entities (e.g., for owners or between owners and recipients).

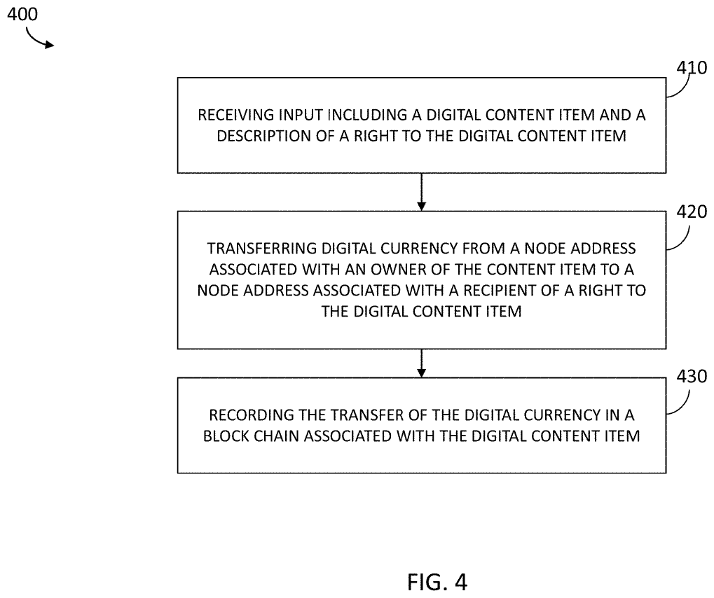

FIG. 4 is a flow diagram illustrating a method 400 for transferring rights assigned to digital content between entities. The method 400 may be performed by the content management system 400 and, accordingly, is described herein merely by way of reference thereto. It will be appreciated that the method 400 may be performed on any suitable hardware or devices/components within the content management system 110.

In operation 410, the content management system 110 registers a digital content item or items received from an owner or provider of the digital content. In some cases, during registration of a digital content item, the content management system 110, via the content registration module 210, may receive input from the owner that includes the digital content item and a description of the right to the digital content item to be provided to recipients, generate a parent, or first, address node as a bitcoin address that represents a right to be assigned to the digital content item or items (and, subsequently provided to recipients), and transfer digital currency from a rightbase, or any other input address controlled and maintained by the content management system 110, to the parent address node to create the right to the digital content item.

In operation 420, the content management system 110 transfers digital currency from a parent address node associated with an owner of a digital content item to a child address node associated with a recipient of a right to the digital content item. The transaction module 220 may perform various different transactions, based on a right type for the right assigned to the digital content item being transferred to the recipient. For example, the transaction module 220 may perform a complete transfer of rights from one entity to another, may provide a clone (or, copy) of rights to one or more entities, and so on.

For example, when performing a transfer of rights from one entity to another, the transaction module 220 receives input from the owner that includes a request to transfer the right to the digital content item to the recipient, generates the child address node as a bitcoin or other digital currency address that represents the recipient, and transfers digital currency from the parent address node to the child address node of the recipient.

As another example, when performing a transfer of a clone (or another instance) of rights to one or more entities, the transaction module 220 transfers digital currency from a rightbase to the parent address node to maintain the right to the digital content item for the owner, receives input from the owner that includes a request to provide a clone of the right to the digital content item to the recipient, and generates the child address node as a bitcoin address that represents the recipient. Thus, the transfer of the digital currency from the parent address node associated with the owner of the digital content item to the child address node associated with the recipient of the right to the digital content item provides the recipient with the clone of the right to the digital content item.

To avoid possible “double spending” of the digital currency associated with node addresses (where an address node performs multiple digital currency transfers to different entities, introducing uncertainty to the tracked provenance of digital content), the transaction module 220, during performed transactions, transfers an entire digital currency balance associated with a parent address node to the child address node.

Also, when performing digital currency transfers between address nodes, the transaction module 220 may attach data to one or more zero value outputs (e.g., OP_RETURN in bitcoin) provided by the scripting system during digital currency transactions. For example, the transaction module 220 may associate data to the transfer of the digital currency that includes information identifying a type of the right to the digital content item provided to the recipient and information associated with a digital contract that contains a description of the right to the digital content item provided to the recipient. Thus, the transaction record associated with the transaction may include, in addition to information identifying the transferring and receiving node addresses, data identifying the type of right and the contract representing the right to the digital content item.

In operation 430, the content management system 110 records the transfer of the digital currency from the parent address node to the child address node in a blockchain associated with the digital content item. For example, the public ledger module 230 generates or updates a blockchain of transaction entries for the digital content item, such as with a transaction entry representing the transfer of digital currency from the parent node address to the child node address.

For example, Table 1 is an example of a public ledger that tracks digital currency transfers as rights transactions for a digital content item:

TABLE 1

| Date | Transaction |
|---|---|
| Jan. 1, 2015 | 29b33fc07a0192e9c1d50da2850f36bca946a8f047bf743719a62207ab85586b |
| Jan. 15, 2015 | 2850f36bca946a8f047bf743719a62207ab85586b29b33fc07a0192e9c1d50da |
| Mar. 20, 2015 | b0886fd9cf0322b0d6910040cbcf158c7bdd538952dd7a5a01bd892f8de6b6c8 |
| . . . | . . . |

As shown in Table 1, the transaction “29b33fc07a0192e9c1d50da2850f36bca946a8f047bf743719a62207ab85586b” represents an initial creation of rights for a newly registered digital content item, while transaction “2850f36bca946a8f047bf743719a62207ab85586b29b33fc07a0192e9c1d50da” represents a transfer of the rights to a second entity.

Following the example, Table 2 is an example of details associated with a currency transfer, such as the transaction that occurred on 01-01-2015:

TABLE 2

| Transferring Entity | Receiving Entity | Contract |
|---|---|---|
| 1EwBV346uW9cGrzsZfFkdZfN3jNAhwG5Cr | 1GrgYzJMSgbLUtXRBQsViYrmod1FxgYsjp | Contract_2 |

As shown in Table 2, the transaction details include the node address for the transferring entity, or former owner of the rights to the digital content item, the node address for the receiving entity, or new owner of the rights to the digital content item, and information identifying the contract that defines and/or represents the rights to the digital content item. Of course, Table 1 and Table 2 may include more or different information than what is depicted, such as information associated with the transaction, information associated with the digital content item, and so on.

Thus, the content management system 110 tracks the provenance of digital content items via a recordation of digital currency transactions between node addresses representing transferring and receiving entities on public ledgers.

As described herein, the content management system 110 utilizes digital currency transfers to validate and represent rights transfers between entities for digital content items. What follows are details regarding these digital currency transactions, and how they map to the transfers of rights between entities.

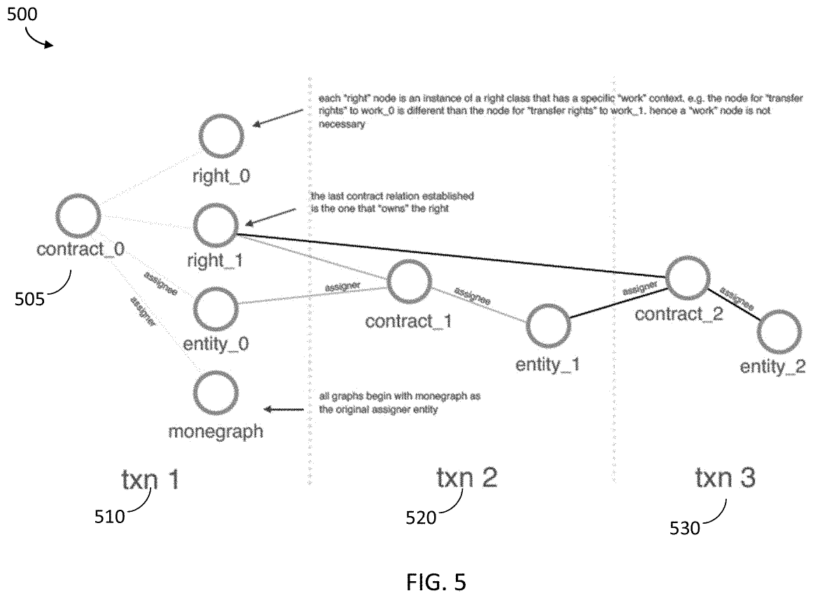

FIG. 5 is a schematic diagram 500 illustrating a transfer of rights assigned to digital content between entities. A first transaction 510 associated with a contract 505 (e.g., “contract_0”) occurs when a common assignor entity (“monegraph”, or the content management system 110) assigns the rights of a work (“right_1”) to an entity (“entity_0”), such as a creator of a work newly registered to the content management system 110, while maintaining original rights (“right_0”) to the work.

A rights transfer transaction 520 occurs when the assignor (entity_0) assigns the rights (right_1) represented by an updated contract (“contract_1”) to a recipient entity (“entity_1”). A subsequent rights transfer transaction 530 occurs when the current owner of the rights to the work, “entity_1,” assigns the rights (right_1) represented by an updated contract (“contract_2”) to a second recipient entity (“entity_2”).

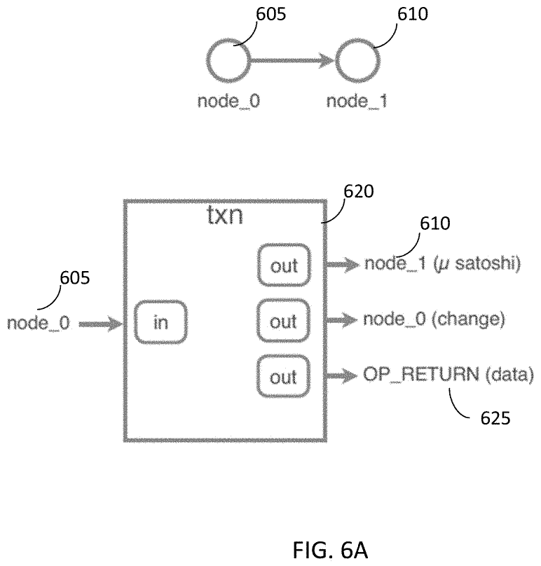

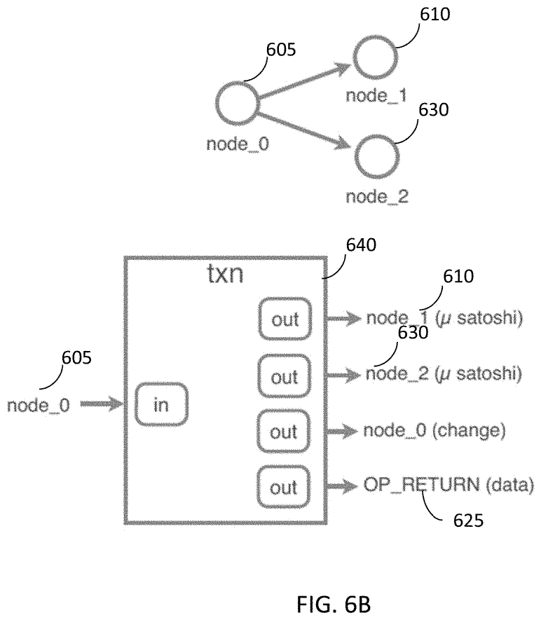

FIGS. 6A-6B are schematic diagrams illustrating a transfer of digital currency during a rights transaction (e.g., transactions 510, 520, and/or 530) for digital content. For example, FIG. 6A depicts a directed graph relationship where a parent node 605 asserts a relationship to a child node 610 by sending, or transferring, digital currency to the child node. For example, a transaction 620 occurs when the parent address node 605 transfers μ satoshi (or, some other small amount of digital currency) to the child address node 610. The transaction 620 also associates certain data/information (e.g., right type information, hash value representing a contract) to the transaction 620 via a zero value output (e.g., OP_RETURN 625).

As another example, FIG. 6B depicts a directed graph relationship where a parent node 605 asserts a relationship to multiple child nodes (e.g., node 610 and node 630) by sending, or transferring, digital currency to the child node. For example, a transaction 640 occurs when the parent address node 605 transfers μ satoshi (or, some other small amount of digital currency) to the child address node 610 and the child address node 630. The transaction 640 also associates certain data/information (e.g., right type information, hash value representing a contract) to the transaction 620 via a zero value output (e.g., OP_RETURN 625).

The content management system 110 may implement and/or follow certain rules or controls when performing transactions between nodes that represent entities. The content management system 110 controls an input address(e.g., “rightbase”), of which all transactions are based or derived. Rightbase may be, for example, a coinbase for rights, and serve to establish an initial right or rights by providing an initial address from which one or more transactions originate. The content management system 110, therefore creates a right for a digital content item (e.g., when the digital content item is registered into the system 110) by transferring μ satoshi from the rightbase to an address, now called a “right-address.”

In some embodiments, therefore, right or rights transactions may only include “right-addresses” or rightbase as input addresses, and “right-addresses” or rightbase as output addresses. As described herein, when a right transaction occurs, all input addresses (except rightbase) may spend their entire unspent balance of digital currency. By causing all transactions to completely spend associated digital currency, the content management system 110 may prevent double spends on rights (where no change is given to a right-address (only rightbase can receive change).

In some embodiments, “satoshi pollution” may occur, where funds are transferred to a right-address that are non-rights related. The content management system 110 may mitigate such occurrences by generating right-addresses concurrently to when a right is transferred to an entity, and by transferring an entire balance associated with the right-address.

As described herein, a right transaction includes an OP_RETURN or other zero sum output, which includes an identification of the type of right being transferred, combined with a hash of a digital contract that describes the right. Therefore, the proof-of-existence for a right may be defined by a node address that has: (1) an unspent balance, and that is associated with transactions that contain an OP_RETURN output that includes a right type identifier and a hash value representing a digital contractual document that describes the right (e.g., an open digital rights language, or ODRL, document). Thus, transactions for a “right-address” may be traced back to a transaction initiated by rightbase.

When a digital content item is registered with the content management system 110, the system 110 creates a bitcoin or other node address to represent a contract that defines the right assigned to the digital content item, and a node address for every right to be established and assigned to the digital content item. These are called “created rights.” Once created, the content management system 110 transfers, for example, μ satoshi from rightbase to each of the created rights addresses, along with data attached via an OP_RETURN output.

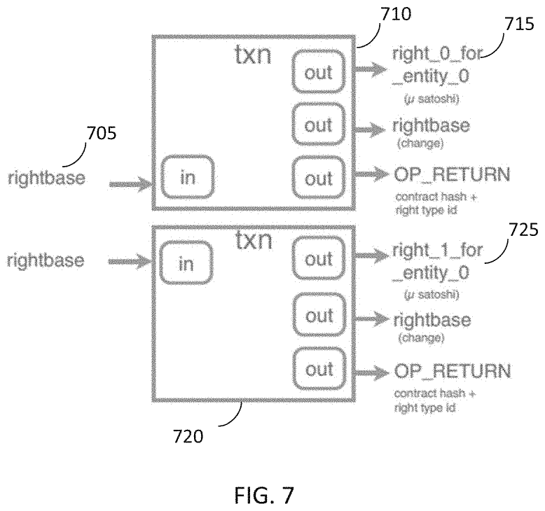

FIG. 7 is a schematic diagram illustrating a creation of a right assigned to digital content. Transaction 710 occurs when rightbase 705 transfers μ satoshi to a first created right address 715 (“right_0_for_entity_0”), and transaction 720 occurs when rightbase 705 transfers μ satoshi to a second created right address 725. Thus, for an associated digital content item, the content management system 110 performs transactions 710 and 720 to create rights 715 and 725, respectively.

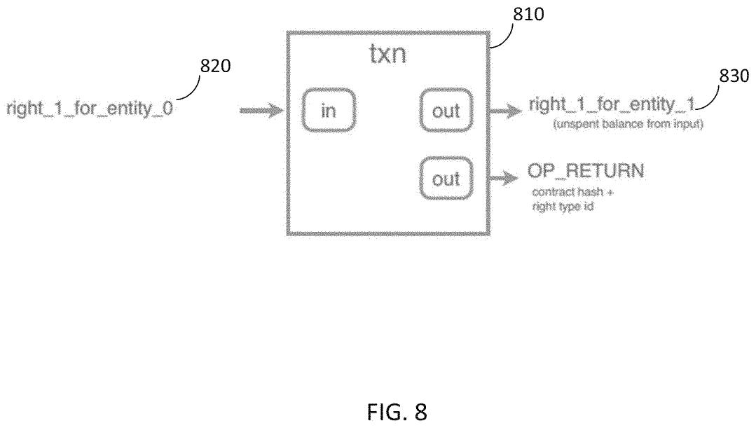

When entity_0 wishes to transfer their right to a digital content item to entity_1, the content management system 110 creates a node address to hold and maintain the right for entity_1. FIG. 8 is a schematic diagram illustrating a transfer of a right assigned to digital content. A transaction 810 occurs where an entire unspent balance of μ satoshi transfers from a node address 820 (e.g., “right_1_for_entity_0”) of a current right holder to a node address 830 (e.g., “right_1_for_entity_1”) of a new right holder, along with data attached via an OP_RETURN output.

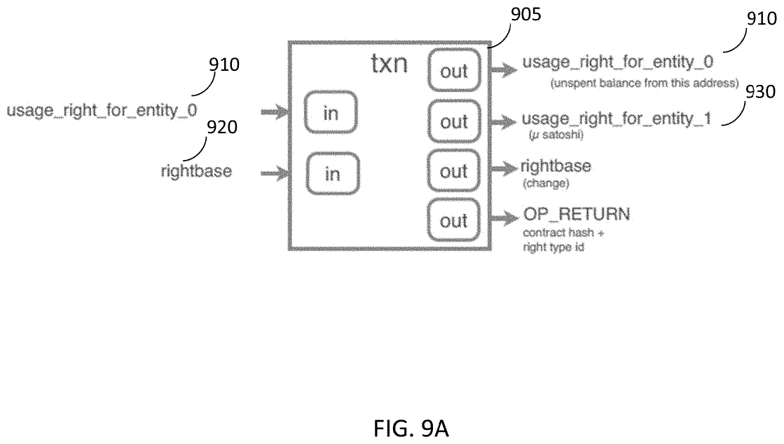

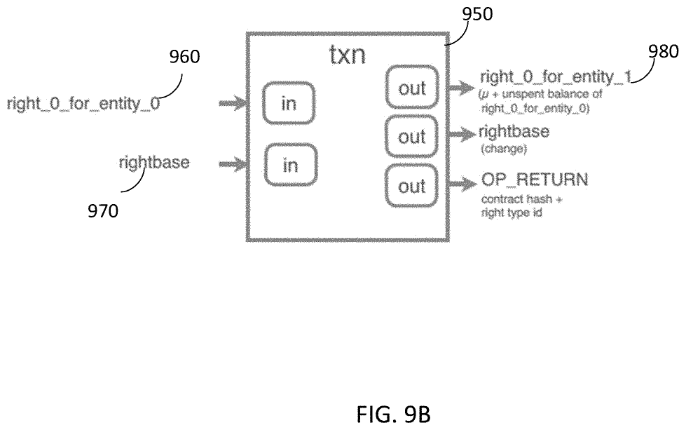

In some embodiments, contractual models may be associated with cloning or duplicating an existing right to a digital content item, wherein an assignee entity is granted a “usage right,” while the assignor entity also retains a usage right and control of other usage rights. FIG. 9A is a schematic diagram illustrating a cloning of a right assigned to digital content. The content management system 110 creates a new address for the newly assigned right (the cloned right), and performs a transaction 905 where both the original right address 910 (e.g., “usage_right_for_entity_0”) and rightbase 920 transfer μ satoshi to the original right address 910 and the new address 930 (e.g., “usage_right_for_entity_1”), along with data attached via an OP_RETURN output

In some embodiments, mining fees associated with mining digital currency may cause unspent balances associated with right-addresses to fall below a minimum transaction amount (e.g., ˜5000 satoshi) and/or applied transaction fees (e.g., ˜10,000 satoshi). During such occurrences, as depicted in FIG. 9B, the content management system 110 performs a transaction 950 where both the original right address 960 (e.g., “right_for_entity_0”) and rightbase 970 transfer μ satoshi to the new right address (e.g., “right_0_for_entity_1”) 980.

In other words, the content management system 110, via the transaction module 220, may determine that an amount of digital currency associated with the parent address node is below a threshold minimum transaction amount, and transfer digital currency from a rightbase to the child address node associated with the recipient of the right to the digital content item.

In some embodiments, the content management system 110 may provide a mechanism for a right holding entity to lease rights to a digital content item. For example, an entity may lease their right to sell royalty free usage for a work to another entity for one year, and after the year, claim the right to sell royalty free usage from the lease, where the lease is no longer able to sell royalty free usage for the work.

Using the “lock time” mechanism for digital currency, the content management system 110 generates two transactions, a first transaction where the right is transferred from the leaser to the lease, and a second transaction, having a set lock time of one year, wherein the right is transferred back to the leaser.

As described herein, the content management system 110 may provide content management for a variety of different online environments, such as online marketplaces, social network services (e.g., Facebook, LinkedIn, Twitter, and so on), micro-blogs (e.g., Twitter, Pinterest, Tumblr, Instagram), blogs, e-commerce sites, auction sites, NFT marketplaces, and other environments that support the creation, introduction, sharing, purchase, licensing, renting, and/or consumption of content.

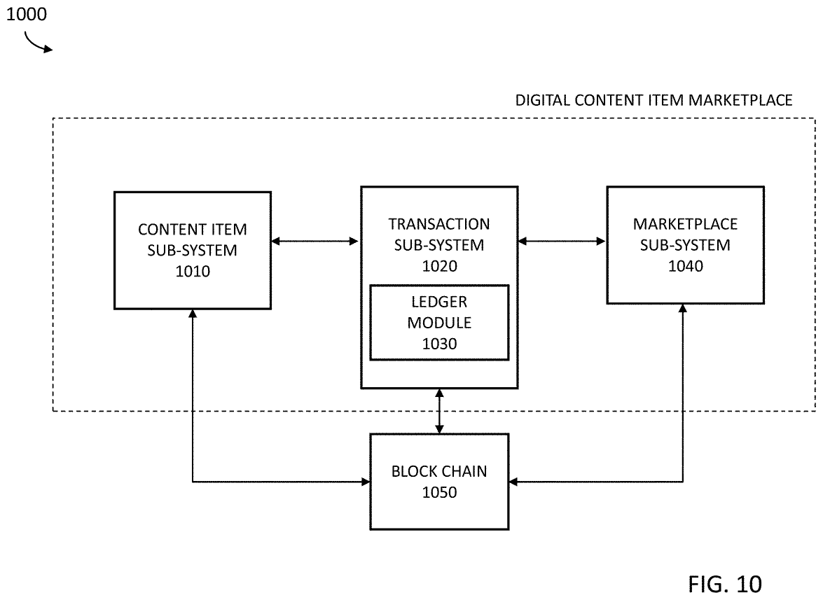

FIG. 10 is a block diagram illustrating systems, or sub-systems of a digital content item marketplace 1000. The marketplace 1000 includes a content item sub-system 10101, a transaction sub-system 1020, and a marketplace sub-system 1030.

In some embodiments, the content item sub-system 1010 receives and manages digital content items, such as images, audio files, video clips, bundles or collections of content, and other multimedia works. The digital content items may include content from owners of digital content items wishing to register the digital content items as available for purchase or licensing via the marketplace sub-system 1030.

In some embodiments, the transaction sub-system 1020 performs blockchain transactions associated with transferring rights to use the digital content items managed by the content item sub-system 1010. For example, the transaction sub-system 1020 may utilize a ledger module (as described herein) to transfer one or more rights to use a digital content item from an owner to a recipient by transferring digital currency from a parent address node associated with the owner of the digital content item to a child address node associated with the recipient of the digital content item within a blockchain 1050 or other public ledger, and recording the transfer of the digital currency from the parent address node to the child address node in the blockchain 1050.

In some embodiments, the marketplace sub-system 1030 facilitates the brokering of rights to the digital content items between owners of the digital content items and recipients of the digital content items. For example, the marketplace sub-system 1030 facilitates:

the selling of an exclusive right to a digital content item from an owner of the digital content item to a recipient of the digital content item;

the selling of a right to an edition of a digital content item from an owner of the digital content item;

the brokering of rights to the digital content items between members of an online social network service (e.g., Twitter or Facebook);

the brokering of rights to the digital content items within an online retail site (e.g., e-commerce site, gallery site, and so on); and other rights or online sites described herein.

The marketplace 1000, therefore, enables rights to digital content items to be exchanged between parties within various online environments (e.g., online media host site 140) while tracking the ownership or provenance of the right to the content via blockchain and other public ledger transactions (e.g., the various different digital currency transactions described herein).

Thus, the marketplace 1000, in some embodiments, may be associated with or support an electronic platform or online portal that facilitates the purchase of rights to digital content items, where the platform includes the marketplace sub-system 1030 to facilitate a brokering of rights to digital content items between owners of the digital content items and recipients of the digital content items, and the transaction sub-system 1020 performs blockchain transactions associated with transfers of rights the digital content items from owners of the digital content items and recipients of the digital content items.

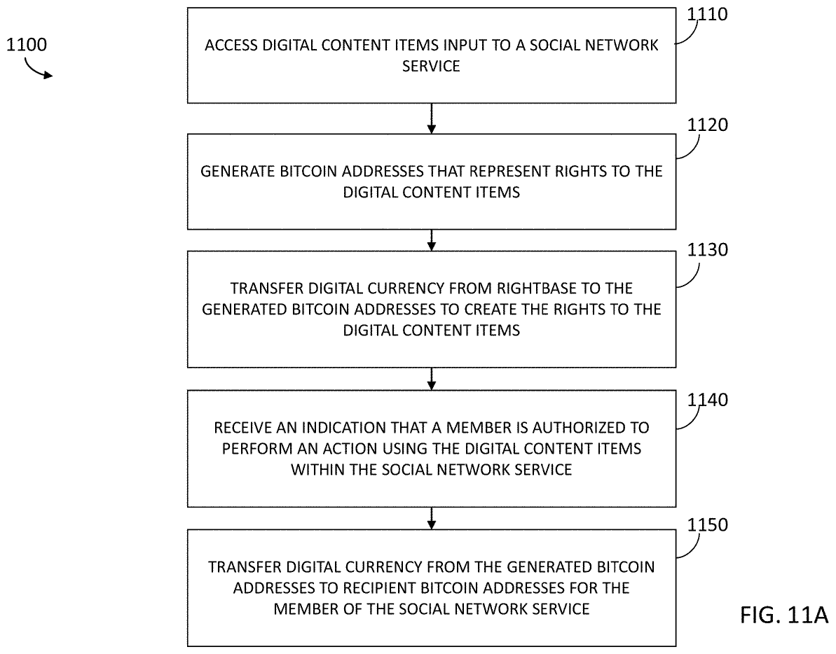

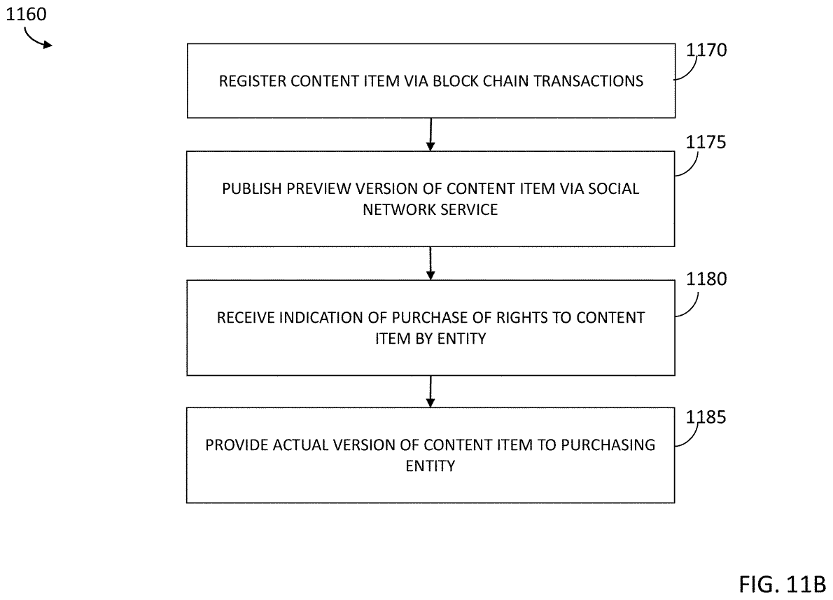

The marketplace 1000 and its sub-systems 1010,1020,1030 may facilitate the managing of content within a social network service (e.g., via the content management system 110). FIG. 11A is a flow diagram illustrating a method 1100 for managing content within a social network service. The method 1100 may be performed by the content management system 110 and/or components of the marketplace 1000 and, accordingly, is described herein merely by way of reference thereto. It will be appreciated that the method 1100 may be performed on any suitable hardware or devices/components within the content management system 110 or marketplace 1000.

In operation 1110, the content management system 110 or marketplace 1000 accesses digital content items input to the social network service by a member of the social network service. For example, the content management system 110 may access photos and videos uploaded to a member profile for a member of the social network.

The content management system 110 or marketplace 1000 registers the accessed digital content items input by the member to the social network service by, in operation 1120, generating bitcoin addresses that represents rights to the digital content items, and, in operation 1130, transferring digital currency from a rightbase controlled by the content management system 110 to the generated bitcoin addresses to create the rights to the digital content items. Thus, the content management system 110 may register and assign rights to digital content provided to the social network service (as described herein)

In operation 1140, the content management system 110 or marketplace 1000 receives an indication that another member of the social network service is authorized to perform an action associated with the digital content items within the social network service. For example, the other member may be authorized (implicitly or explicitly) to share or modify the digital content items within other areas of the social network service.

For example, the marketplace sub-system 1030 may receive an indication that the member of the social network service is connected to an owner of the digital content items within the social network service and/or may receive an indication that the member of the social network service is a first degree connection of an owner of the digital content items within the social network service.

Members of social network services may perform various different actions using digital content items, when authorized by owners of the digital content items. For example, the members may:

share the digital content items within a post published to the social network service (e.g., a post made to the member's profile or other area within the social network service);

post a feed item within the social network service that includes one or more of the digital content items, such as a post or feed item made to a feed accessible by some members of the social network service (e.g., connections to the member or original owner of the content item), and/or a feed accessible by all members of the social network service or any online viewers of the feed (e.g., an open Twitter feed);

The content management system 110 or marketplace 1000, in operation 1150, transfers digital currency from the generated bitcoin addresses to recipient bitcoin addresses associated the other member of the social network service, and records the transfer of the digital currency in a blockchain associated with the digital content items. For example, the transaction sub-system 1020 may transfer digital currency from the generated bitcoin addresses associated with the rights to the digital content items to bitcoin addresses associated with the member of the social network service after the member of the social network service shares a digital content item within the social network service.

Social network services (e.g., Facebook, Twitter, and so on) often provide their members and other users with various types of information or content, such as content associated with trending topics or events, current or topical news stories, and so on. The services may act as platforms for quick and efficient dissemination of information to many people, including content provided by their members and users. The systems described herein, in some embodiments, provide mechanisms to control the sharing, licensing, purchasing, and so on, of content provided by users to the social network services and shared or otherwise utilized by other members or users (e.g., news or corporate entities) for financial or advertising gains, among other things.

The marketplace 1000 and its sub-systems 1010,1020,1030 may regulate the use or sharing of content within a social network service (e.g., via the content management system 110). FIG. 11B is a flow diagram illustrating a method 1160 for sharing content within a social network service or other online environment. The method 1160 may be performed by the content management system 110 and/or components of the marketplace 1000 and, accordingly, is described herein merely by way of reference thereto. It will be appreciated that the method 1160 may be performed on any suitable hardware or devices/components within the content management system 110 or marketplace 1000.

In operation 1170, the content management system 110 or marketplace 1000 registers a digital content item to the social network service by performing a blockchain transaction within a blockchain associated with the social network service, as described herein.

In operation 1175, the content management system 110 or marketplace 1000 publishes a preview version of the digital content item within the social network service. For example, the preview version may be a watermarked version of the digital content item (e.g., an image of a photo with an applied watermark), a low-resolution version of the digital content item (e.g., a low resolution image of a photo), an abridged version of the digital content item (e.g., the first few seconds of a video of a topical event), and so on.

In operation 1180, the content management system 110 or marketplace 1000 receives an indication of a purchase of rights to the digital content item by an entity associated with the social network service. For example, the content management system 110 or marketplace 1000 may receive an indication that the entity associated with the social network service has purchased an exclusive right to the digital content item, that the entity associated with the social network service has purchased a right to an edition of the digital content item, that the entity associated with the social network service has purchased, a right to remix the edition of the digital content item, and/or various combinations of rights to digital content items, as described herein.

In operation 1185, the content management system 110 or marketplace 1000 provides an actual version of the digital content item to the entity that purchased the rights to the digital content item. For example, the actual version may be an unedited or source version of the digital content item, a high-resolution version of the digital content item, a complete version of the digital content item (e.g., the complete video of the topical event), and so on.

The content management system 110 or marketplace 1000 may transfer digital currency from a parent address node associated with an owner of the digital content item to a child address node associated with the entity that purchased the rights to the digital content item, record the transfer of the digital currency from the parent address node to the child address node in the blockchain associated with the social network service, and provide the actual version of the digital content item to the entity that purchased the rights to the digital content item after the transfer of the digital currency from the parent address node to the child address node is recorded in the blockchain associated with the social network service.

Thus, in some embodiments, the content management system 110 or marketplace 1000 enables users of social network services to be compensated and/or otherwise control or manager the use of the digital content they provide to various different social network services. The following scenarios may utilize aspects of the marketplace 100 described herein.

As a first scenario, the content management system 110 or marketplace 1000 may facilitate the licensing or purchasing of content provided by users during “breaking news” scenarios where many different users are providing content to a social network service during an ongoing event.

For example, a user captures a photo or video of an ongoing event or scenario (e.g., a video of footage of a crime scene), and publishes the video to his social network service feed after registering the photo via the marketplace 1000. The marketplace 1000 causes the video to be published as an abridged version. A news outlet (e.g., entity) reporting on the ongoing event takes an exclusive license to various rights to use and remix the video, and the marketplace 1000 facilitates a payment from the entity to the user for the exclusive license to the rights. The news outlet receives a complete version of the video, and shares the video within various feed items published to the social network service by the news outlet.

As a second scenario, the content management system 110 or marketplace 1000 may facilitate an entity licensing or purchasing content from users during the “breaking news” scenarios.

For example, the news outlet described herein publishes a feed item to the social network service requesting content associated with a certain ongoing event (e.g., feed items having a hashtag associated with the ongoing event—“#ongoingevent”). The news outlet reviews user submissions (e.g., tweets or other posts that include the hashtag or are direct replies to the request), having a preview version of relevant content, and selects content from one or more of the posts for purchase or licensing from the owners of the content. The marketplace 1000 facilitates a payment from the news outlet to the users providing the selected content, and provides the news outlet with a complete version of the content, which shares the content within various feed items published to the social network service by the news outlet. Of course other scenarios may be supported by the marketplace 1000.

Thus, in some embodiments, the marketplace 1000 enables social networks and other online environments that present and enable the use of content to regulate and track use of the content by all members, among other benefits.

As described herein, in some embodiments, the content management system 110 manages the transfer of rights to digital content between parties (such as between owners of the content and recipients of the content). Often, each content item is associated with a collection of similar, yet different rights to the content. For example, the rights to a digital content item may include a right to use the digital content item, a right to an exclusive use of the digital content item, a right to an edition (e.g., 1 edition of 10 total versions) of the digital content item, a right to modify or remix the digital content item, a right to the title (or, to change the title) of the digital content item, a right to resell or transfer use of the digital content item, and so on.

In order to track the various rights registered, assigned, and/or transferred with respect to digital content, the content management system 110 may generate digital contracts that include the collection of rights for digital content. A digital contract, therefore, may include information associated with rights assigned to the digital content (e.g., blockchain addresses established for each right), as well as information representing the digital content and other information, such as plain language information for the contract. The digital contract, therefore, is an electronic document or file that includes a set of blockchain addresses that represent the rights assigned to a digital content item.

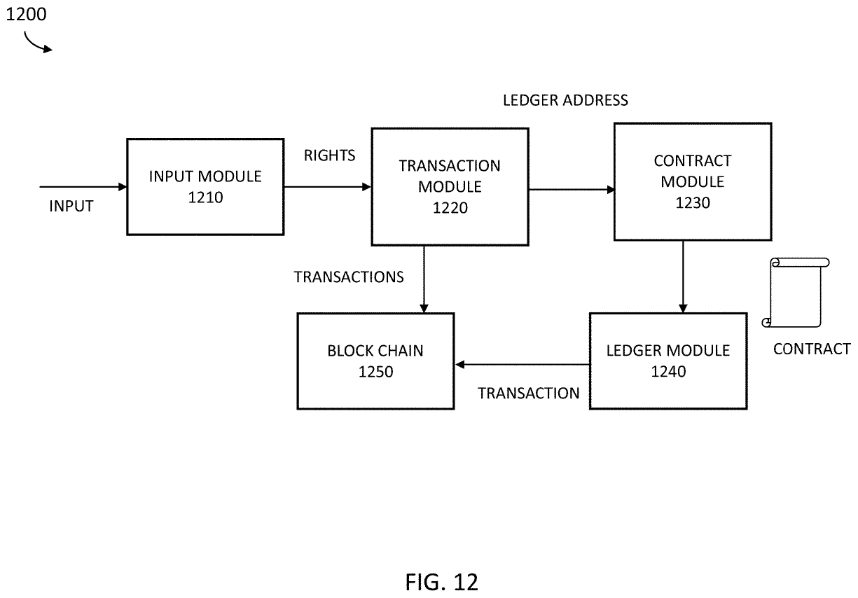

FIG. 12 is a block diagram 1200 illustrating interactions between components during the creation of a digital contract of rights to a digital content item. These components may form a system for generating a digital contract for rights to a digital content item, and include an input module 1210 that receives input associated with rights assigned to a digital content item, a transaction module 1220 that performs blockchain transactions within a blockchain 1250 for each of the rights identified by the input module 1210, and a contract module 1230 that generates a digital contract that includes the rights assigned to the digital content item and, via a ledger module 1240, performs a transaction to register the digital contract within the blockchain 1250.

In some embodiments, the input module 1210 receives input associated with transferring rights of a digital content item to a recipient. For example, the input module may receive associated with transferring rights of the digital content item to the recipient via a user interface provided or rendered by the content management system 110 that includes multiple user-selectable options associated with rights to be transferred to the recipient. Example user-selectable options include:

user-selectable options associated with a transaction type for a transfer of rights to the recipient;

user-selectable options associated with a type of the digital content item;

user-selectable options associated with a version of the digital content item;

user-selectable options associated with a price for rights to the digital content item;

user-selectable options associated with a right to modify the digital content item; and so on.

In some embodiments, the transaction module 1220 performs one or more blockchain transactions to register each right of the digital content item to transfer to the recipient to a public ledger or blockchain 1250. As described herein, the transaction module 1220 may generate an address node as a bitcoin address that represents a right to be provided to a recipient, and transfer digital currency from a rightbase (e.g., address associated with the content management system 110) to the address node to create the right to the digital content item.

For example, the transaction module 1220 performs a separate transaction (e.g., currency transfer) for each right assigned to the digital content item. Example transfers include:

a digital currency transfer transaction between address nodes to register a title of the digital content item;

a digital currency transfer transaction between address nodes to register a right to transfer the title of the digital content item to a recipient;

a digital currency transfer transaction between address nodes to register a right to remix the digital content item by a recipient;

a digital currency transfer transaction between address nodes to register a right to transfer a right to remix the digital content item to a recipient; and so on.

In some embodiments, the contract module 1230 performs a blockchain transaction to register a digital contract that includes information representing each of the performed one or more blockchain transactions to the public ledger. For example, the contract module 1230 generates the digital contract as a collection of the rights that includes node addresses registered to the public ledger 1250 that represent each of the rights to the digital content transferred to the recipient.

The digital contract may include various types of information, and include both encrypted (e.g., un-accessible) and unencrypted (e.g., accessible) portions or sections. For example, a generated digital contract may include:

a first unencrypted portion that includes the information representing each of the performed one or more blockchain transactions to the public ledger;

a second unencrypted portion that includes a digital fingerprint representing the digital content item; and/or

an encrypted portion that includes a plain language version of the rights transferred to the recipient.

The contract module 1230 may register the digital contract to the public ledger by transferring digital currency from a parent address node to a child address node associated with registering the digital contract to the block ledger, and recording the transfer of the digital currency from the parent address node to the child address node in the public ledger. In some cases, the contract module 1230 associates data to the transfer of the currency (e.g., via an OP_RETURN field in a bitcoin transaction) that includes information representing a digital fingerprint of the digital contract (e.g., a SHA-256 hash value of the contract), and information representing a contract type for the digital contract, among other information.

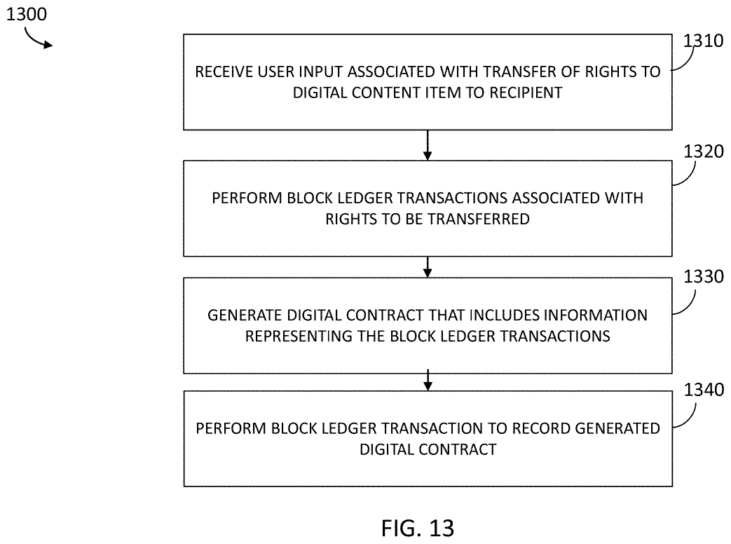

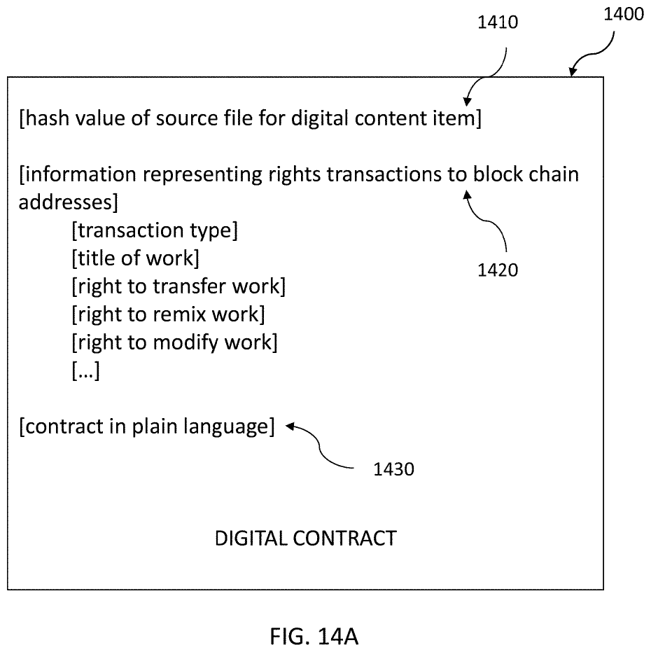

Thus, the content management system 110 may perform various methods or processes when generating digital contracts, or other collections of rights assigned to digital content items. FIG. 13 is a flow diagram illustrating a method 1300 for generating a digital contract of rights to a digital content item. The method 1300 may be performed by the content management system 110 and, accordingly, is described herein merely by way of reference thereto. It will be appreciated that the method 1300 may be performed on any suitable hardware or devices/components within the content management system 110.

In operation 1310, the content management system 110 receives input associated with transferring rights of a digital content item to a recipient. For example, the input module may receive associated with transferring rights of the digital content item to the recipient via a user interface provided or rendered by the content management system 110 that includes multiple user-selectable options associated with rights to be transferred to the recipient.

In operation 1320, the content management system 110 performs one or more blockchain transactions to register each right of the digital content item to transfer to the recipient to a public ledger. For example, the transaction module 1220 may generate an address node as a bitcoin address that represents a right to be provided to a recipient, and transfer digital currency from a rightbase (e.g., address associated with the content management system 110) to the address node to create the right to the digital content item. The transaction module 1220 may perform a separate transaction (e.g., currency transfer) for each right assigned to the digital content item.

In operation 1330, the content management system 110 performs a blockchain transaction to register a digital contract that includes information representing each of the performed one or more blockchain transactions to the public ledger. For example, the contract module 1230 generates the digital contract as a collection of the rights that includes node addresses registered to the public ledger 1250 that represent each of the rights to the digital content transferred to the recipient.

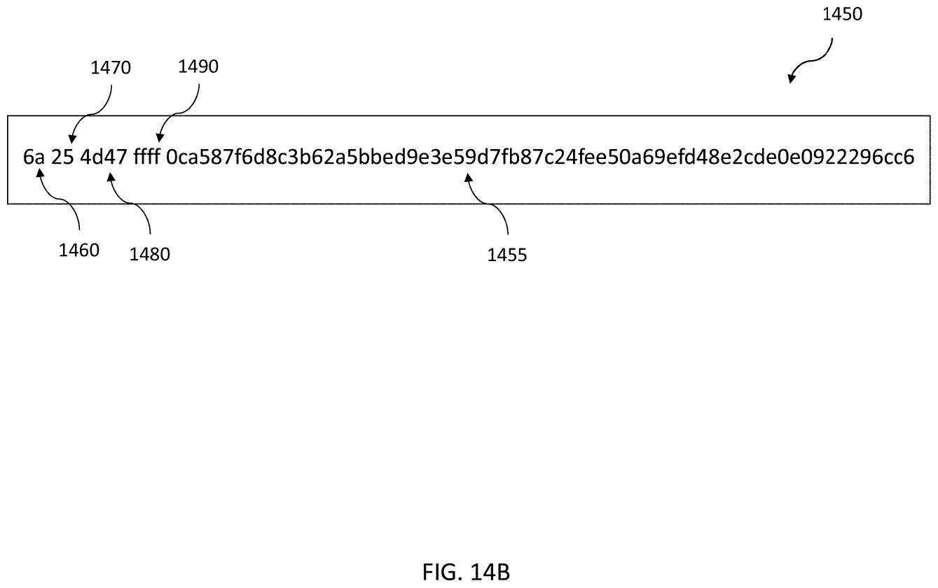

FIG. 14A depicts an example digital contract 1400 of rights to a digital content item. The digital contract 1400 includes information representing the digital content item 1410 (e.g., a hash value of a source file of the digital content item), information representing rights transactions to blockchain addresses 1420 (e.g., the first or initial addresses that received a digital currency transfer to establish the rights to the digital content item), and other information (optionally encrypted or private) 1430, such as plain language information for the contract.

The information representing the rights to the digital content items 1420 may be a group of blockchain addresses (e.g., bitcoin addresses) associated with each right, as registered on the blockchain, and, as shown in the Figure, may include an address associated with a transaction type to transfer to the digital content item, a right to the title of the digital content item, a right to transfer the digital content item, a right to remix the digital content item, a right to resell the digital content item, a right to modify the digital content item, and other rights described herein.

Referring back to operation 1330, the contract module 1230 may register the digital contract to the public ledger by transferring digital currency from a parent address node to a child address node associated with registering the digital contract to the block ledger, and recording the transfer of the digital currency from the parent address node to the child address node in the public ledger. In some cases, the contract module 1230 associates data to the transfer of the currency (e.g., via an OP_RETURN field in a bitcoin transaction) that includes information representing a digital fingerprint of the digital contract (e.g., a SHA-256 hash value of the contract), and information representing a contract type for the digital contract, among other information.

FIG. 14B is a representation of information 1450 associated with a digital content item that is included in a blockchain transaction to register the digital contract within a blockchain or public ledger. The information 1450 accompanying the digital currency transaction may include:

information representing a digital fingerprint of the digital contract (e.g., a SHA-256 hash value) 1455;

information representing a content management specific identifier for the version of the contract (e.g., version “00”) 1460;

information representing the document type for the digital contract 1465;

information representing the digital fingerprint is part of the content management system 1465 (for discoverability within the blockchain); and

information representing the number of bytes in the digital fingerprint (e.g., “25” in the hexadecimal) 1470; and/or

information representing an instruction that this is a message to include with a currency transaction (e.g., within the OP_RETURN field in a bitcoin transaction) 1475. Of course, other information may be included.

Therefore, the content management system 110 may perform multiple digital currency transfers between address nodes to register a collection of rights to a digital content item to a blockchain, and perform a digital currency transfer transaction between address nodes to register the collection of rights to the blockchain. These transactions function to establish the rights to the digital content item via the blockchain, and record the transfer of ownership via a digital contract) to the blockchain, providing a transparent way of tracking and maintaining the provenance to the rights to use digital content items, among other benefits.

As described herein, the input module 1210 may render, present, display, or cause to be displayed a series of user interfaces that enable a user or owner of a digital content item to register a work and rights to the work within the content management system 110.

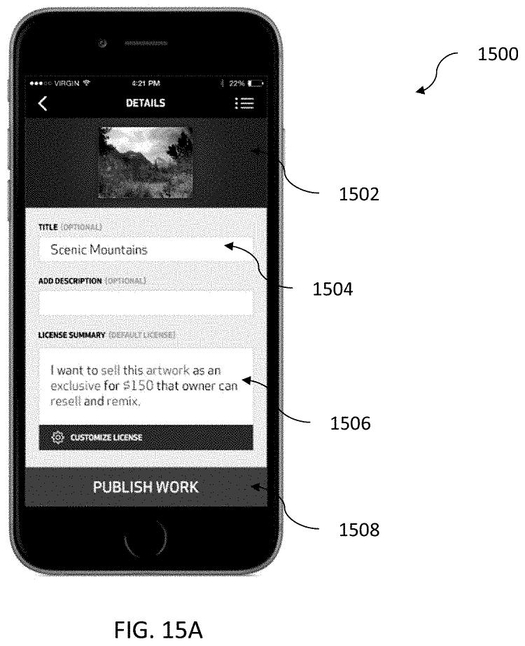

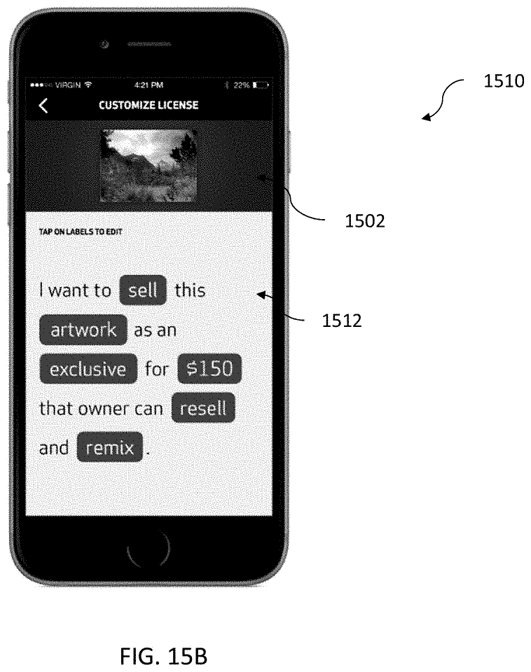

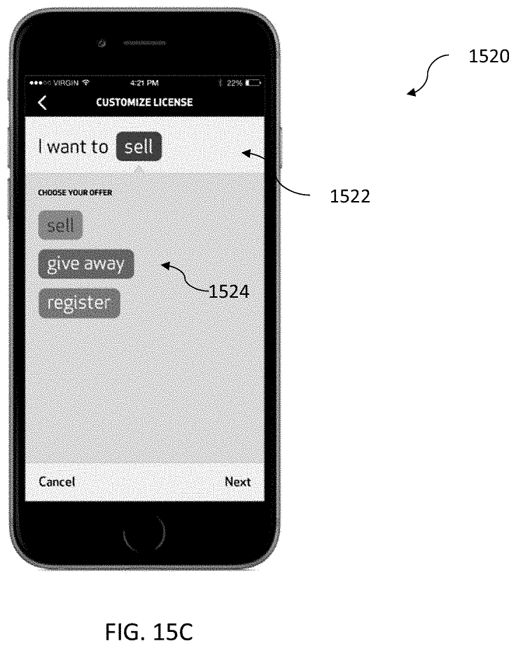

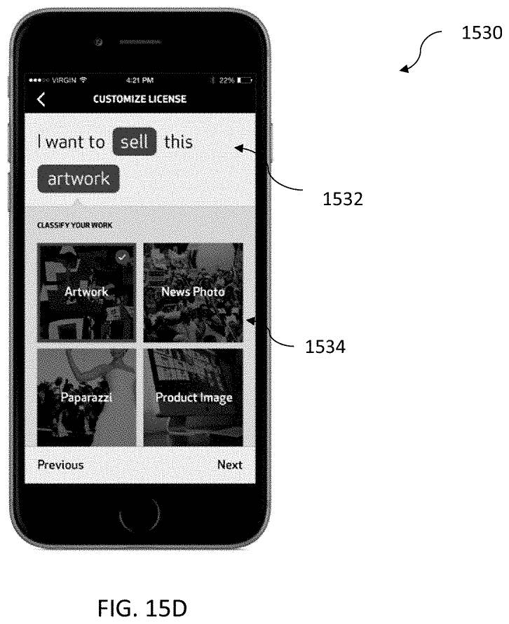

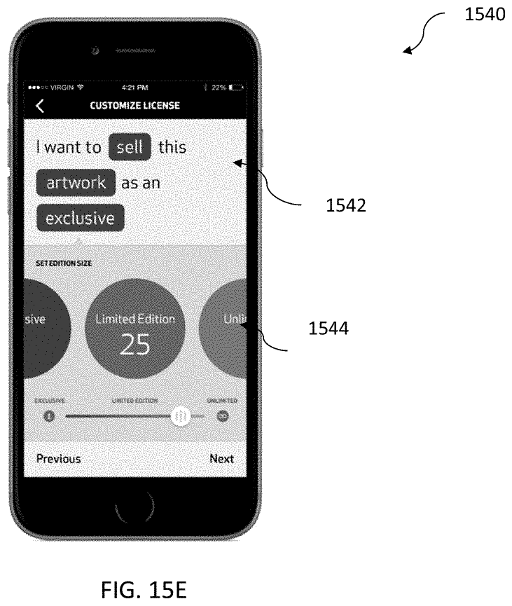

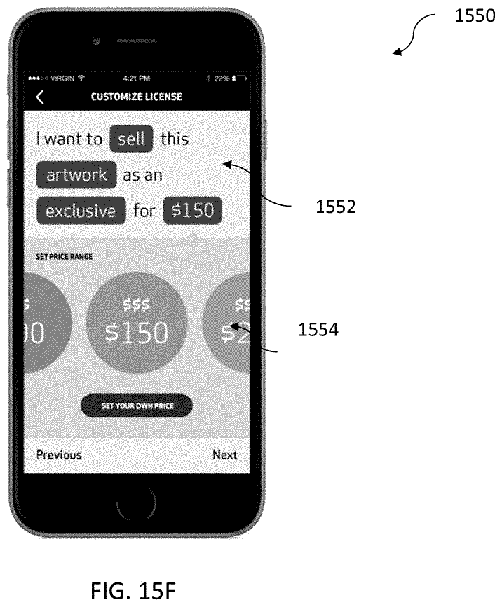

FIG. 15A depicts a user interface 1500 via which an owner of a work may register the work to the content management system 110. The user interface 1500 displays an image of the work 1502, a editable title field 1504 and description field via which the owner may input title and other description information for the work, a license summary field 1506 that displays the rights to be assigned to the work (to be configured by the owner), and a user-selectable button 1508, that, when selected by the owner, causes the content management system 110 to perform the various processed described herein and register the work (and, associated rights to the work) to the content management system 110 by performing one or more blockchain transactions.

FIG. 15B depicts a user interface 1510 whereby an owner may select or adjust the rights to be assigned to the work 1502 (via user-selectable options for each of the rights). For example, the user interface 1510 shows the initial rights assigned to the work 1502, as “I want to SELL this ARTWORK as an EXCLUSIVE for $150 that owner can RESELL and REMIX.”

FIG. 15C depicts a user interface 1520 that facilitates the customization of the license, whereby an owner adjusts the transaction type right to be assigned to the work 1502. For example, the user interface 1520 shows the selected transaction type 1522 (“I want to sell”), and user-selectable options 1524 associated with different selectable transaction types (e.g., “sell,” “give away,” or “register”).

FIG. 15D depicts a user interface 1530 that facilitates the customization of the license, whereby an owner adjusts the type of the work 1502. For example, the user interface 1530 shows the selected type of work 1532 (“I want to sell this artwork”), and user-selectable options 1534 associated with different work types (e.g., “artwork,” “news photo,” “product image,” or “paparazzi”).

FIG. 15E depicts a user interface 1540 that facilitates the customization of the license, whereby an owner adjusts the number of available editions of the work 1502. For example, the user interface 1540 shows the selected edition of work 1542 (“I want to sell this artwork as an exclusive”), and user-selectable options 1544 associated with different edition sizes (e.g., “edition of 25”).

FIG. 15F depicts a user interface 1550 that facilitates the customization of the license, whereby an owner adjusts the price of the work 1502. For example, the user interface 1550 shows the selected price of the work 1552 (“I want to sell this artwork as an exclusive for $150”), and user-selectable options 1554 associated with different prices for the work, such as system generated prices, user input prices, and so on. Of course, the content management system 110 may present other user interfaces not shown herein when facilitating the customization of licenses for digital content items.

Thus, in some embodiments, the content management system 110 provides mechanisms for owners of digital content to customize licenses to the rights of the digital content. Once the input is received, the content management system 110 registers the digital content by performing various blockchain transactions for some or all of the user-configurable rights within the licenses, as described herein.

### Examples of on Chain Storage of Documents

As described herein, in some embodiments, the systems and methods facilitate the storage of documents, such as legal documents, along with associated tokens (e.g., non-fungible tokens or NFTs) to a blockchain or similar platform, such as the Ethereum decentralized platform. The systems and methods can utilize standards embedded in the platforms as storage mechanisms. For example, the systems and methods can utilize an Ethereum standard for tokens (e.g., ERC-721 and/or ERC-1155), such as ERC-721, a standard for creating non-fungible tokens.

The ERC-721 standard sets forth a few basic functions. The standard provides a Mint( ) function, which creates, or mints, the token, and a Transfer( ) function, which moves the token to another Ethereum address. In some cases, a DelegatedTransfer( ) function can extend the transfer by enabling a 3rd party (e.g., an NFT marketplace) to effect a transfer of the token on the owner's behalf. Further, the standard allows for optional parameters to be included with the minted token. For example, the token can include a name for an associated digital content item, a symbol for the associated digital content item, and tokenURI (uniform resource indicator) data.

The tokenURI can specify information about the digital content, such as an artist name, title of the content, description, and/or a link (a uniform resource locator, or URL) to where the content is stored (e.g., an IPFS address). The tokenURI points to a JSON file (.json formatted file) that is stored at a location external to the blockchain (e.g., not in an ERC-721 smart contract that generates the token). Thus, the token can include a reference to the URL, while the JSON file that includes the metadata for the digital content item is external to the blockchain.

While some technologies store legal documents (or related documents or content items) associated with NFTs off-chain due to the transactional costs or fees (e.g., “gas” in Ethereum), off-chain storage has various disadvantages. For example, such storage can rely on additional parties to keep data immutable and preserved outside of the decentralized platform managing the NFT and associated rights to the NFT (such as various content items described herein).

The disclosed technology facilitates the storage of documents associated with NFTs on-chain (e.g., within the Ethereum platform or another decentralized platform) at fractional transactional costs (e.g., 1/20 of typical costs). The technology utilizes, and expands upon, the event and logging mechanism of Ethereum. For example, smart contracts can emit events and/or write logs, which are then linked in perpetuity to the smart contract that issues the events/logs.

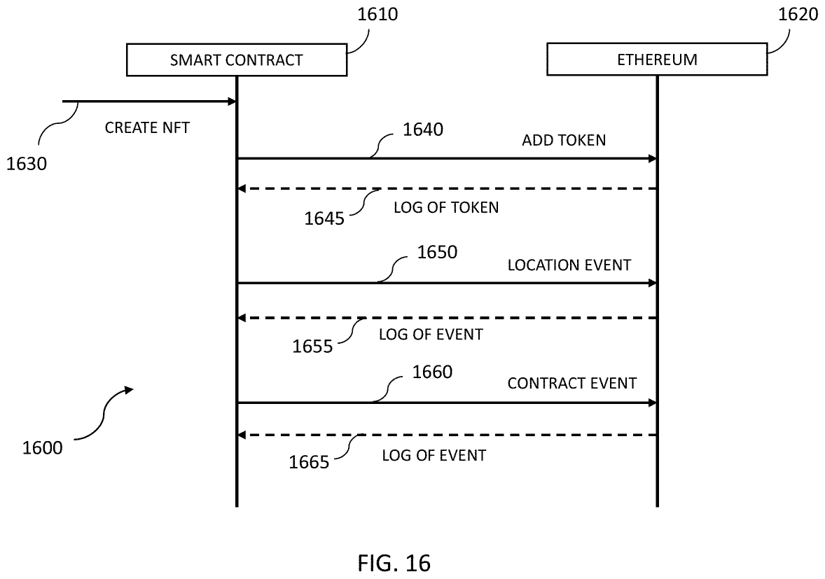

FIG. 16 is a diagram illustrating flows between a smart contract 1610 and a decentralized platform 1620, such as Ethereum, to store a document on a blockchain. For example, the technology invokes an NFT to mint a new token 1630. The platform passes associated NFT parameters (e.g., token URI, owner address or wallet, other metadata) as well as additional parameters for documents that should be associated with the NFT, such as an associated real-world legal contract, information identifying originals of the NFT (e.g., source location information such as IPFS or another file sharing system), and so on.

While performing a single transaction, the platform mints the NFT 1640 and, via the event mechanism of Ethereum, emits events (and/or writes logs) related to or associated with the additional parameters for the documents or information associated with the NFT (e.g., logs the token 1645 to the blockchain). For example, the platform, via the single transaction, can emit a location event 1650 that identifies the location of the original asset for the NFT (along with associated logging 1655 of the event), a contract event 1660 that includes information associated with the real-world contract defining rights to the NFT (along with associated logging 1665 of the event), and so on.

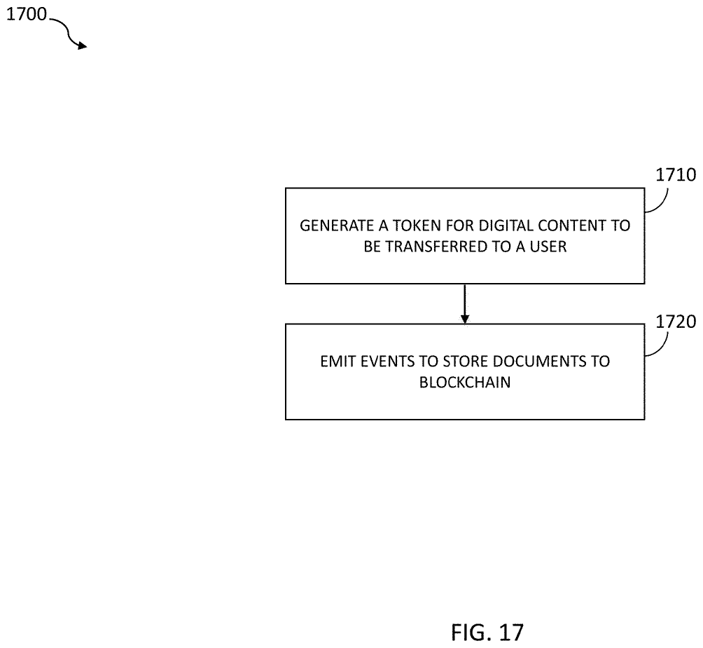

FIG. 17 is a flow diagram illustrating an example method 1700 for providing digital content to a user. The method 1300 may be performed by the platform and, accordingly, is described herein merely by way of reference thereto. It will be appreciated that the method 1700 may be performed on any suitable hardware.

In operation 1710, the platform generates a token for digital content. For example, in response to a sale or transaction associated with the digital content sold as part of an auction or other online sale), the platform generates, or mints, a non-fungible token (NFT) to represent the digital content on the blockchain. The platform can utilize a standard, such as the ERC-721, when minting the token.

In operation 1720, the platform emits one or more events to store documents associated with the digital content. For example, the platform can emit the location event 1650 and/or the contract event 1660 to store information associated with the digital content, such as contract information for the transaction or rights associated the digital content, the location of the digital content (e.g., the IPFS location), and so on.

Thus, when an NFT is issued to a new owner, the additional documents and information are already associated, on-chain, with the NFT. Further, since the events and NFT originate from the same, single, transaction, the platform provides a mechanism to verify or prove that the events occurred at the time of the NFT was issued (and not at a later point).

Further, the platform can utilize the event mechanism to amend legal documents, source locations, and other information associated with an issued NFT. For example, suppose a creator of an NFT has the right to increase the creator fee after five years. Via the platform, the creator can issue a new event associated with the token, resulting in the new event superseding the old, original event, while still maintaining a relationship to the original transaction that issued the NFT. Thus, the platform can facilitate new contract events, new location update events, and so on, throughout the life of the NFT.

### Examples of a Decentralized Auction Platform

As described herein, in some embodiments, the systems and methods provide an auction platform for auctioning or otherwise selling digital content items, such as NFTs and other blockchain-based or blockchain-issued content. For example, the auction platform can utilize the Ethereum platform to generate/mint NFTs representing the digital content items (e.g., using the ERC-721 standard as described herein) and facilitate auctions for ownership or rights to the content represented by the generated NFTs. Example NFT represented content, or digital content items, can include audio files, video files, image files and photos, digital services (e.g., streaming media or events), and other digital files.

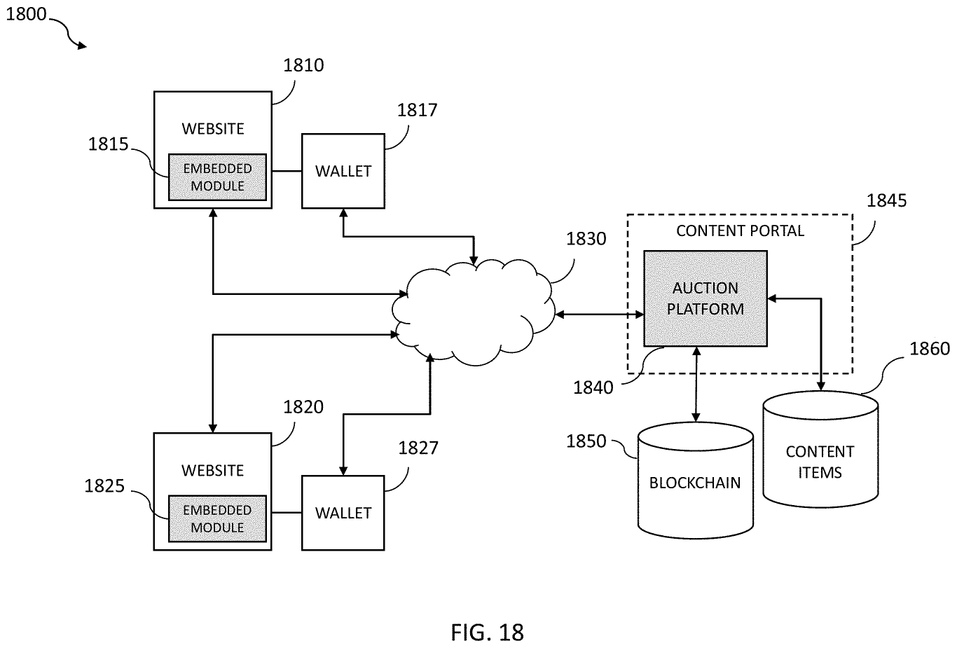

FIG. 18 is a block diagram illustrating a suitable network architecture 1800 for accessing a decentralized auction platform via websites. The network architecture 1800 includes multiple websites 1810, 1820 that communicate with an auction platform 1840, such as an NFT auction platform, over a network 1830. The websites 1810, 1820 include embedded modules 1815, 1825, which facilitate access to the auction platform 1840.

For example, a user of the website 1810 can bid on an NFT (or other content item) presented by the auction platform 1840 via the embedded module 1815, which can include an embeddable link, space, or other embeddable code supported by the website 1815. Similarly, a user of a second website, such as the website 1820, can also bid on the NFT (or other content item) presented by the auction platform 1840 via its embedded module 1825, which can include an embeddable link, space, or other embeddable code supported by the website 1825 and/or injected into the website 1825.

The embedded modules 1815, 1825, therefore, enable any or multiple websites to facilitate access to the auction platform 1840, regardless of whether the websites are associated with the auction platform 1840 and/or content presented by the platform 1840. The websites 1815, 1825, can include websites or portals associated with content publishers (e.g., news or information sites, gallery sites, retail sites, and other content providers), brokers, exchanges, and so on. The embedded code 1815, 1825 can present information about available content as well as information or user interface elements that facilitate the purchase of items, the bidding on items, and so on.

The auction platform 1840 manages and/or facilitates the auction of digital content items, such as NFTs (and associated data) stored within a content database 1860 or other source location, such as IPFS. The auction platform 1850 also interacts with a blockchain 1850 or another decentralized chain or registry, such as the Ethereum platform, as described herein.

The auction platform 1840 is accessible via multiple different websites, portals, and/or applications via embedded links or other similar code (e.g., modules 1815, 1825). The auction platform 1840 can utilize various smart contract mechanisms to support the auction of digital content items, such as:

A. Buy Now Auction—an auction mechanism that persists a buy now price, persists a bid history, persists a current high bidder, checks for bids after closure of an auction, checks for incorrect purchase prices, and closes an auction after a first successful bid (e.g., a bid that matches a set “Buy Now” price);

B. Auction Beacon—an auction mechanism utilized to create new auctions, the beacon can internally deploy a smart contract for an auction, pointing to an implementation contract. In some cases, the beacon is only invoked by a contract administrator (e.g., providing security), and can implement access controls (e.g., what admins or users (or associated digital wallets) can access or modify the auction;

C. Migration Contracts—Built in from Truffle (or other development applications), a migration contract can be utilized to run scripts that modify current contracts and/or utilized to deploy new implementations of other contracts (e.g., Buy Now) and update auction beacons so all contracts successfully updated.

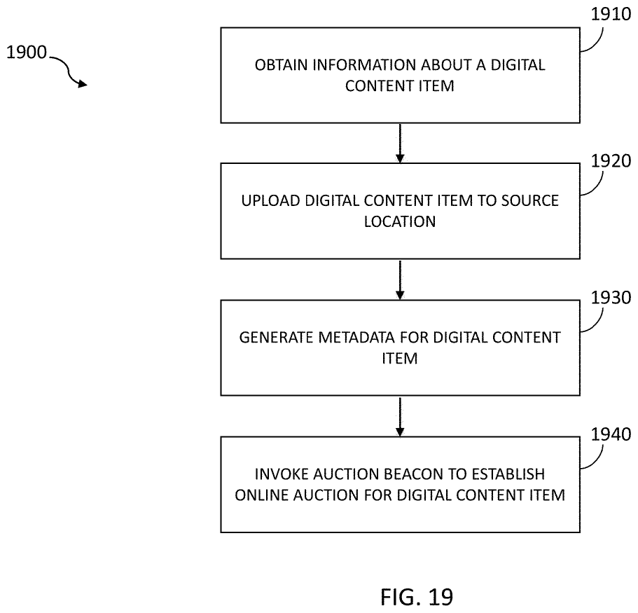

The auction platform 1840 can create an auction in a variety of ways. FIG. 19 is a flow diagram illustrating an example method 1900 for establishing an online auction service for a digital content item. The method 1900 may be performed by the auction platform 1840 and, accordingly, is described herein merely by way of reference thereto. It will be appreciated that the method 1900 may be performed on any suitable hardware.

In operation 1910, the auction platform 1840 obtains or accesses information about a digital content item. For example, the platform 1840 can obtain information about a seller's wallet address, a desired reserve price for the digital content item to be auctioned, and so on.

In operation 1920, the auction platform 1840 uploads the digital content item (e.g., an NFT or other content described herein) to a source location. For example, the auction platform 1840 can upload or transfer the digital content item to am IPFS location or other online storage service or file service.

In operation 1930, the auction platform 1840 creates or generates metadata for the NFT (e.g., using JSON) and uploads the metadata to the source location. For example, the platform 1840 can generate metadata associated with the digital content item and store the metadata as tokenURI data. An associated token can include the tokenURI, and specify information about the digital content, such as an artist name, title of the content, description, and/or a link (e.g., a URL) to where the content is stored (e.g., the IPFS address). The tokenURI can point to the JSON file (.json formatted file) that is stored at the location external to the blockchain.

In operation 1940, the auction platform 1840 invokes a beacon contract (e.g., via an admin account) to establish the auction. Of course, the platform 1840 can utilize other steps or operations. For example, the platform 1840 can cause an auction beacon to internally deploy a smart contract for the auction, which causes a token to be minted and the auction to be established.

Referring back to FIG. 18, every user (e.g., bidder) and seller can be associated with a digital wallet or smart wallet, which stores currency (e.g., bitcoin, ETH, and other digital currencies) for purchasing digital content items, such as NFTs. For example, a user of website 1810 has a wallet 1817, and a user of website 1820 has a wallet 2127.

In some cases, the auction platform 1840 can authorize users to participate in an auction based on contents within their wallets 1817, 1827. For example, the auction platform 1840 can determine the user associated with the wallet 1817 has a certain amount of ETH and authorize the user to bid or purchase items via a presented auction. In contract, the auction platform 1840 can determine the user associated with the wallet 1827 does not have enough ETH and prevent the user from bidding or purchasing items via the presented auction.

Further, in some embodiments, the auction platform 1840 is part of a content distribution portal 1845, which can distribute (e.g., sell, rent, or otherwise provide access) content to users based on a variety of authentication or access control mechanisms. The following section presents additional details regarding operations performed by the content distribution portal 1845.

Examples of the Content Distribution Portal

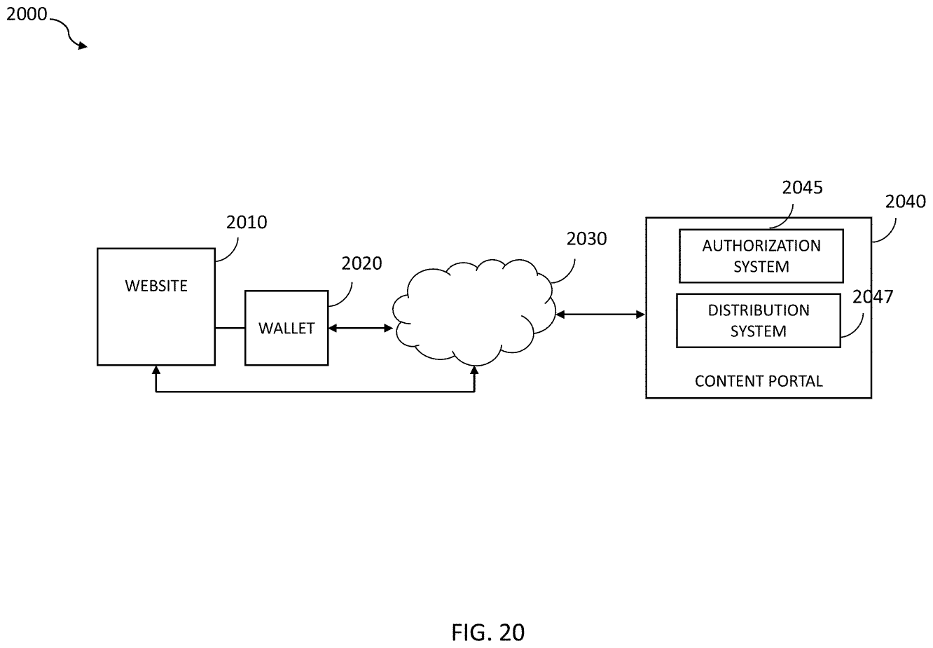

As described herein, in some embodiments, the systems and methods facilitate the control of user access to digital content items, such as NFTs, based on the contents of digital wallets associated with the users. FIG. 20 is a block diagram illustrating a system 2000 for authorizing access to a digital content item via contents of a digital wallet.

As described herein, a user associated with a digital wallet 2020 seeks to access content via a website 2010, such as a publisher, content provider, retailer, broker, exchange, and so on. The website 2010 communicates with a content portal 2040 over a network 2030. The content portal 2040 (e.g., content distribution portal 2045) can include an authorization system 2045, which authorizes users to access content provided by the content portal 2040, and a distribution system 2047, which distributes content (e.g., streams, provides links to source locations, provides access codes, and so on) to authorized users.

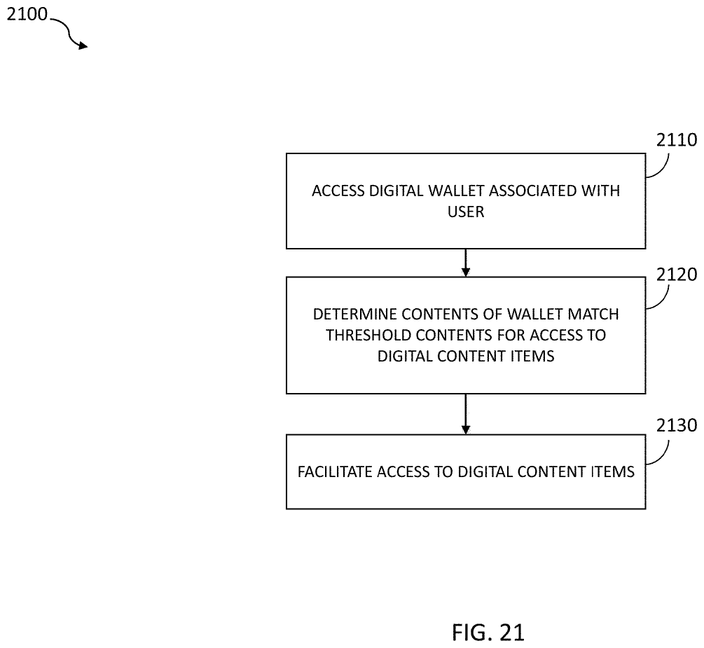

As described herein, the content portal 2040 can perform various methods for facilitating access to digital content, such as NFTs. FIG. 21 is a flow diagram illustrating an example method 2100 of authorizing access to a digital content item. The method 2100 may be performed by the content portal 2040 and, accordingly, is described herein merely by way of reference thereto. It will be appreciated that the method 2100 may be performed on any suitable hardware.

In operation 2110, the portal 2040 accesses a digital wallet associated with a user. For example, the authorization system 2045 can access the wallet 2020 of the user.

In operation 2120, the portal 2040 determines the contents of the wallet 2020 match threshold contents for access to digital content items. For example, the system 2045 can identify whether a user has a certain or threshold amount of currency (e.g., ETH) or certain unique or limited tokens, and determine the user matches the threshold based on the identification of the contents.

The system 2045 can perform various comparisons to determine whether the user is eligible based on wallet contents. In some cases, the system 2045 determines a user is eligible or authorized based on a total amount of currency (e.g., 1 or more ETH). In some cases, the system 2045 determines a user is eligible or authorized based on possession of specific tokens (e.g., owns a unique token for a specific NFT, or owns one of a limited edition of tokens associated with viewing a special edition video or digital performance).

Thus, the system 2045 can map or relate the digital content item with the currency or tokens that facilitate access to the digital content item. Example mappings are presented in the following table:

| Digital Content Item | Minimum wallet contents |
|---|---|
| NFT via auction | Any amount of currency over reserve price |
| Limited video | Unique token associated with video |
| Access to online membership | One membership token, or certain |
| site | currency amount in wallet |
| Access to downloadable app | One token specific to art and certain |
| presenting unique digital art | edition of the art |
| Access to digital distribution | Certain amount of currency |
| platform | |

Thus, the system 2045 can authorize a user based on a variety of authentication rules, policies, or mechanism.

In operation 2130, the portal 2040 facilitates access to the digital content items. For example, the distribution system 2047 can distribute content (e.g., streams, provides links to source locations, provides access codes, unlocks content, and so on) to the authorized user or users.

Thus, in some embodiments, the content portal 2024 facilitates the matching or provision of digital content, digital services (or real world services represented by a digital counterpart) and so on, to items or content within a user's digital wallet, in order to provide access to the content or services.

### Examples of Managing Distribution of Digital Content

As described herein, various content distribution protocols (e.g., ERC-721) lack mechanisms that ensure creators are compensated when their creations (e.g., NFTs or other digital content items) are transferred or resold. The various platforms described herein can control or manage such payments, by facilitating creators to unlock tokens and allow transactions (e.g., transfers of rights to an NFT) to occur. Further, the platforms can perform automatic unlock operations after certain time periods (e.g., a few days after a transaction is completed) to avoid creators from holding up proper transactions.

In some cases, the platforms can track whether payments are made to creators in response to a transaction, and flag (e.g., add a “lien” or indicator) the content that indicates the lack of payment. The purchaser (or seller) can have the flag removed by paying the fee owed to the creator. Thus, the platform managing the digital content can provide accurate or updated information about the content to subsequent purchasers, providing legitimacy and transparency to the sales or distribution of content between parties, among other benefits.

### Conclusion

The techniques introduced herein can be implemented by, for example, programmable circuitry (e.g., one or more microprocessors) programmed with software and/or firmware, or entirely in special-purpose hardwired circuitry, or in a combination of such forms. Software or firmware for use in implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A “computer-readable medium”, as the term is used herein, includes any mechanism that can store information in a form accessible by a machine or computer (a machine may be, for example, a computer, network device, cellular phone, personal digital assistant (PDA), manufacturing tool, any device with one or more processors, etc.). For example, a non-transitory machine-accessible or computer-readable storage medium includes recordable/non-recordable media (e.g., read-only memory (ROM); random access memory (RAM); magnetic disk storage media; optical storage media; flash memory devices; etc.), etc.

These computer program instructions may also be stored in a non-transitory computer-readable medium that can direct a computer, other programmable data processing apparatus, or other devices to function in a particular manner, such that the instructions stored in the computer readable medium produce an object of manufacture including instructions which implement the function/act specified in the flowchart and/or block diagram block or blocks.

The computer program instructions may also be loaded onto a computer, other programmable data processing apparatuses, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowcharts and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

We claim:

1. A system, comprising:
a processor; and
a memory coupled with the processor, the processor configured to:
create a token that is stored on a blockchain and associated with a digital content item; and
emit one or more events associated with the digital content item that store a document that includes information identifying rights to the digital content item to the blockchain.

2. The system of claim 1, wherein the processor is configured to:
mint a non-fungible token (NFT) using an Ethereum standard to store the NFT to an Ethereum platform; and
emit the one or more events based on a smart contract event mechanism of the Ethereum platform.

3. The system of claim 1, wherein the one or more events include:
a contract event that stores a digital contract for the digital content item to the blockchain; and
a location event that stores information identifying an online location of the digital content item to the blockchain.

4. The system of claim 1, wherein the one or more events include a log written to the blockchain by a smart contract associated with the digital content item.

5. The system of claim 1, wherein the one or more events are emitted by a smart contract associated with the digital content item.

6. The system of claim 1, wherein the token is a non-fungible token (NFT) that represents the digital content item on the blockchain.

7. The system of claim 1, wherein the digital content item is a multimedia content item.

8. The system of claim 1, wherein the digital content item is an service accessible via the token.

9. A non-transitory computer-readable medium whose contents, when executed by a computing system, cause the computing system to perform a method of establishing an online auction for a digital content item, the method comprising:
storing a digital content item to an online file service;
generating metadata for the digital content item;
storing the metadata for the digital content item to the online file service; and
invoking an auction beacon to establish an online auction for the digital content item.

10. The non-transitory computer-readable medium of claim 9, wherein invoking an auction beacon to establish an online auction for the digital content item includes executing a smart contract of the auction beacon to mint a non-fungible token (NFT) representing the digital content item to a blockchain.

11. The non-transitory computer-readable medium of claim 9, wherein invoking an auction beacon to establish an online auction for the digital content item includes minting a non-fungible token (NFT) representing the digital content item to the blockchain that includes a tokenURI for the metadata generated for the digital content item.

12. The non-transitory computer-readable medium of claim 9, wherein storing the digital content item to the online file service includes storing the digital content item to an interplanetary file system (IPFS).

13. The non-transitory computer-readable medium of claim 9, wherein storing the metadata includes storing the metadata as a .json formatted file.

14. The non-transitory computer-readable medium of claim 9, wherein the digital content item is a multimedia content item that is represented on the blockchain by a non-fungible token.

15. The non-transitory computer-readable medium of claim 9, wherein the online auction is a buy now auction.

16. The non-transitory computer-readable medium of claim 9, further comprising:
accessing information about the digital content item from a digital wallet associated with a seller of the digital content item,
wherein the information includes information that identifies a reserve price for the digital content item and information that describes the digital content item.

17. A method, comprising:
accessing a digital wallet associated with a user;
determining that content within the digital wallet matches a threshold for accessing a digital content item; and
facilitating access to the digital content item based on the content within the digital wallet.

18. The method of claim 17, wherein determining that content within the digital wallet matches a threshold for accessing a digital content item includes determining that the digital wallet associated with the user includes a minimum value of digital currency for bidding on the digital content item during an online auction.

19. The method of claim 17, wherein determining that content within the digital wallet matches a threshold for accessing a digital content item includes determining that the digital wallet associated with the user includes a token specific to the digital content item.

20. The method of claim 17, wherein determining that content within the digital wallet matches a threshold for accessing a digital content item includes determining that the digital wallet associated with the user includes a token identifying the user as a member of an online service associated with the digital content item.
